(19) United States
(12) Patent Application Publication
(10) Pub. No.: US 2026/0038388 A1
(43) Pub. Date: Feb. 5, 2026

(54) Mobile Sensory Stimulation System

(71) Applicant: Joy Collaborative, Minneapolis, MN (US)

(72) Inventors: Mark Ostrom, Minneapolis, MN (US); Tony Farah, Plymouth, MN (US)

(21) Appl. No.: 19/288,402

(22) Filed: Aug. 1, 2025

Related U.S. Application Data
(60) Provisional application No. 63/678,319, filed on Aug. 1, 2024.

(51) Int. Cl. G09B 19/00; B60P 3/00

(52) U.S. Cl. CPC G09B 19/00; B60P 3/00

(57) ABSTRACT

A sensory stimulation system including a wheeled chassis is disclosed. An enclosure is coupled to the wheeled chassis. The enclosure surrounds an interior space. A sound insulation system at least partly surrounds the interior space. A plurality of sensory elements are provided within the enclosure. The plurality of sensory elements comprise at least one of at least one tactile element defining a textured surface, at least one puzzle, at least one surface configured to permit coloring or drawing and removal of the coloring or drawing, at least one magnetic surface configured to permit arrangement of magnetic elements thereon, or at least one musical instrument.

### CROSS-REFERENCE TO RELATED APPLICATIONS

This applicant claims priority to and the benefit of the filing date of U.S. Provisional Patent Application No. 63/678,319, filed Aug. 1, 2024, the entirety of which is hereby incorporated by reference herein in its entirety.

### FIELD

This disclosure relates to systems for providing multi-sensory spaces.

### BACKGROUND

Multi-sensory spaces can be used to provide stimuli to individuals to regulate sensory experiences. Such multi-sensory spaces can be used by children or autistic individuals for calming or grounding the individuals, as well as for learning or playing. However, these spaces are not always conveniently located. Accordingly, it can be desirable to quickly and economically provide a multisensory space in a desired location.

### SUMMARY

Disclosed herein, in various aspects, is a sensory stimulation system including a wheeled chassis. An enclosure is coupled to the wheeled chassis. The enclosure surrounds an interior space. A sound insulation system at least partly surrounds the interior space. A plurality of sensory elements are provided within the enclosure. The plurality of sensory elements comprise at least one of at least one tactile element defining a textured surface, at least one puzzle, at least one surface configured to permit coloring or drawing and removal of the coloring or drawing, at least one magnetic surface configured to permit arrangement of magnetic elements thereon, or at least one musical instrument.

These and other objects and features of the present invention will become more fully apparent from the following description and appended claims, or may be learned by the practice of the invention as set forth hereinafter.

### BRIEF DESCRIPTION OF THE DRAWINGS

FIG. 1 is a top schematic view of an exemplary sensory stimulation system as disclosed herein, illustrating certain features of the sensory stimulation system.

FIG. 2 is a top schematic view of an exemplary sensory stimulation system as disclosed herein, illustrating certain features of the sensory stimulation system.

FIG. 3 is a top schematic view of an exemplary sensory stimulation system as disclosed herein, illustrating certain features of the sensory stimulation system.

FIG. 4 is a partial interior view of an exemplary sensory stimulation system as disclosed herein.

FIG. 5 is partial interior view of an exemplary sensory stimulation system as disclosed herein.

FIG. 6 illustrates exemplary sensory elements for use with the sensory stimulation system as disclosed herein.

FIG. 7 illustrates exemplary elements for use with the sensory stimulation system as disclosed herein.

FIG. 8 illustrates a schematic top view of an exemplary sensory stimulation system as disclosed herein having two enclosures.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, use of “substantially” (e.g., “substantially parallel”) or “generally” (e.g., “generally planar”) should be understood to include embodiments in which angles are within ten degrees, or within five degrees, or within one degree.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

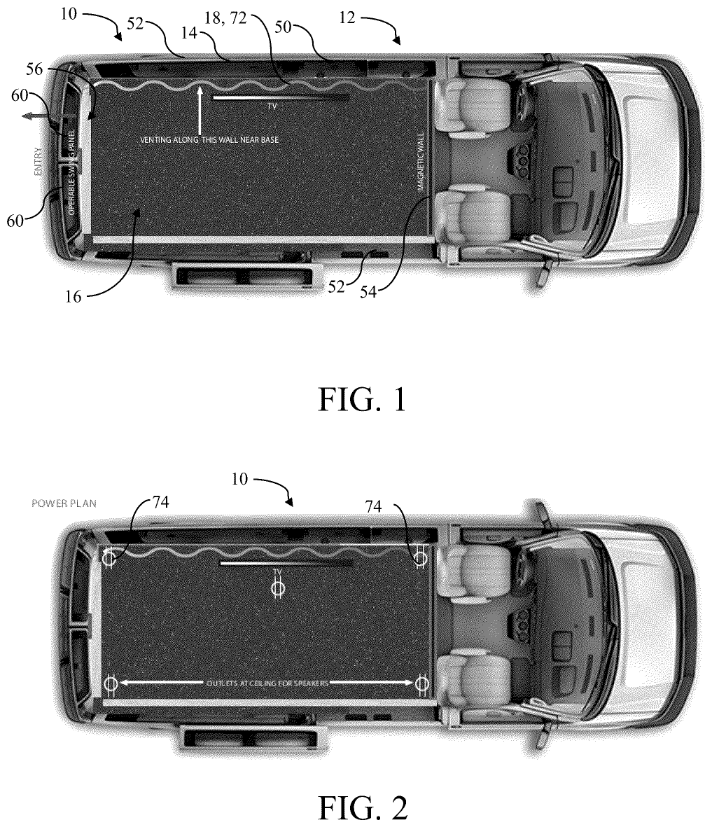

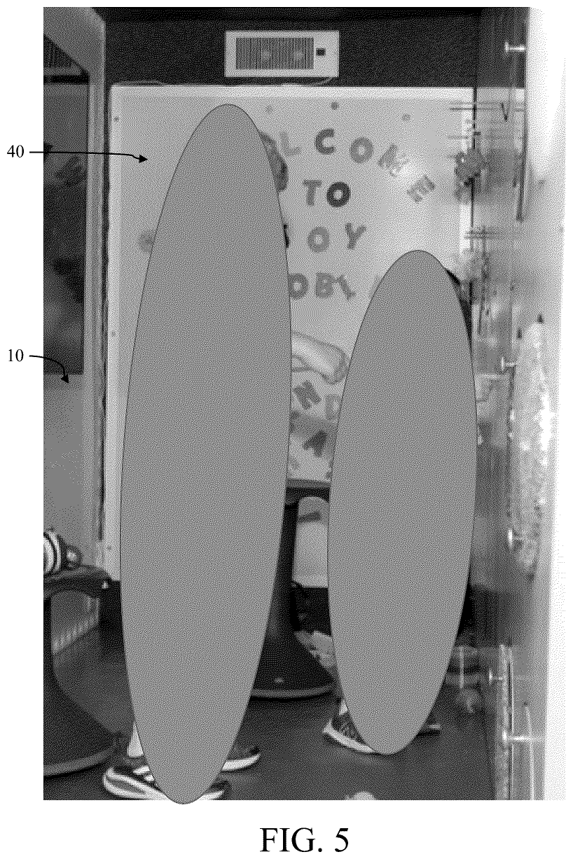

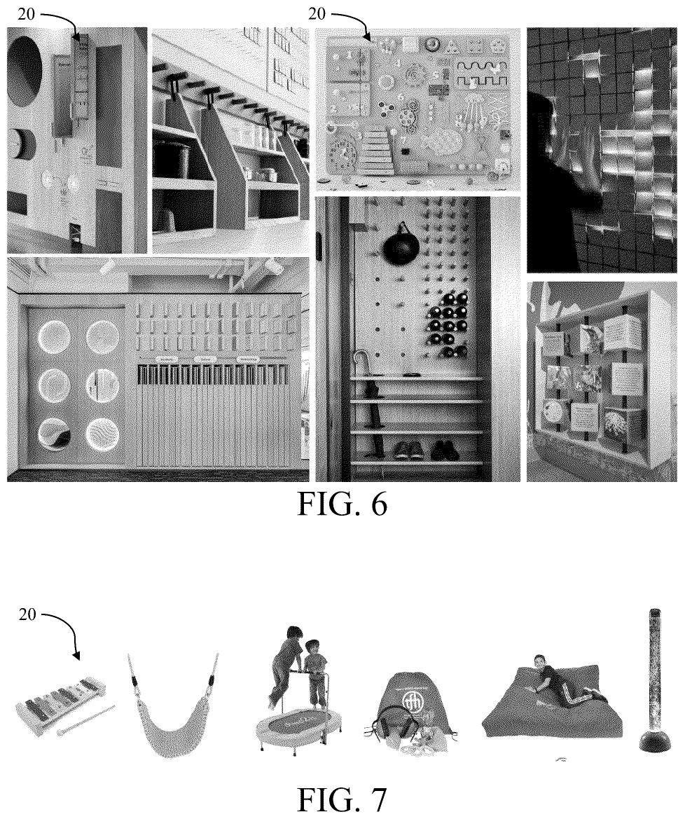

Disclosed herein, in various aspects and with reference to FIGS. 1-5, is a sensory stimulation system 10. The stimulation system 10 comprises a wheeled chassis 12. An enclosure 14 is coupled to the wheeled chassis 12. The enclosure 14 surrounds an interior space 16. A sound insulation system 18 at least partly surrounds the interior space 16. A plurality of sensory elements 20 are provided within the enclosure. The plurality of sensory elements 20 comprise at least one of the following: at least one tactile element 30 defining a textured surface 32, at least one puzzle, at least one surface configured to permit coloring or drawing and removal of the coloring or drawing, at least one magnetic surface 40 configured to permit arrangement of magnetic elements thereon, at least one musical instrument, or at least one mirror.

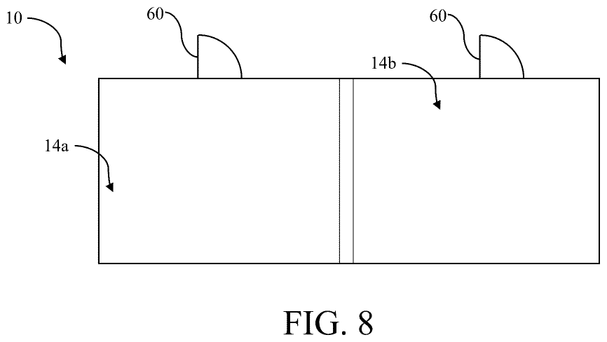

In some aspects, the enclosure 14 can be integrally formed with the wheeled chassis 12. For example, the sensory stimulation system 10 can comprise a vehicle, such as a van, and the van or other vehicle can comprise the enclosure 14 and the wheeled chassis 12. In other aspects, the sensory stimulation system 10 can comprise a trailer. The trailer can comprise the enclosure 14. Optionally, the enclosure 12 can be removable from the wheeled chassis 12. For example, the enclosure 14 can be a container (e.g., a modified shipping container, such as, for example, a pod) that is configured to be selectively positioned on and removed from a trailer. Referring also to FIG. 8, in some aspects, a single unit (e.g., a trailer or container) can define a plurality of enclosures. For example, the single unit can be elongated along a longitudinal axis, and the single unit can define a first enclosure and a second enclosure that are spaced along the longitudinal axis. In some aspects, each enclosure of the plurality of enclosures can have a respective access (e.g., door 60) open to an area outside of the single unit. In some aspects, sound insulation can be provided between the first and second enclosures.

The enclosure 14 can comprise a plurality of walls 50. In various aspects, the plurality of walls can comprise a pair of side walls 52 spaced along a transverse axis. The pair of sidewalls can have forward ends and rear ends. A forward wall 54 can extend between the forward ends of the pair of sidewalls.

The enclosure 14 can further comprise at least one door 60. In some optional aspects, the at least one door 60 can be positioned at the rear ends of the sidewalls. Optionally, the plurality of walls 50 can further comprise a rear wall 56 that is pivotable about and between a first position that extends across the at least one door and a second position that is pivoted away from the first position to permit access to the at least one door. In other aspects, the at least one door can itself define at least a portion of the rear wall. In still further aspects, the at least one door can be positioned on any side of the enclosure to provide access to the interior space 16.

In some aspects, one or more of the plurality of sensory elements 20 can be positioned on respective walls of the plurality of walls. For example, at least one sensory element 20 of the plurality of sensory elements can be positioned on the rear wall.

The enclosure 14 can further comprise a ceiling 62.

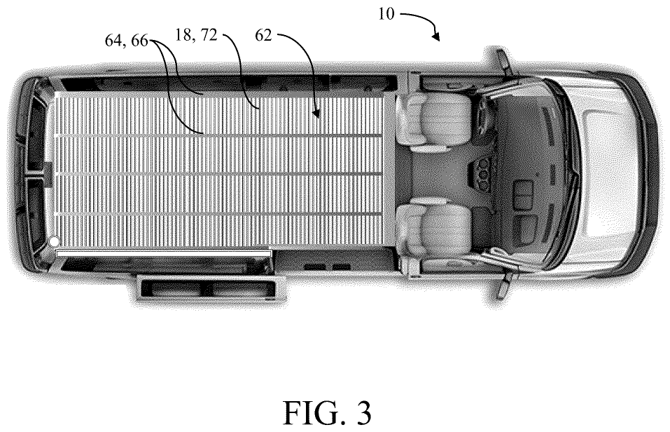

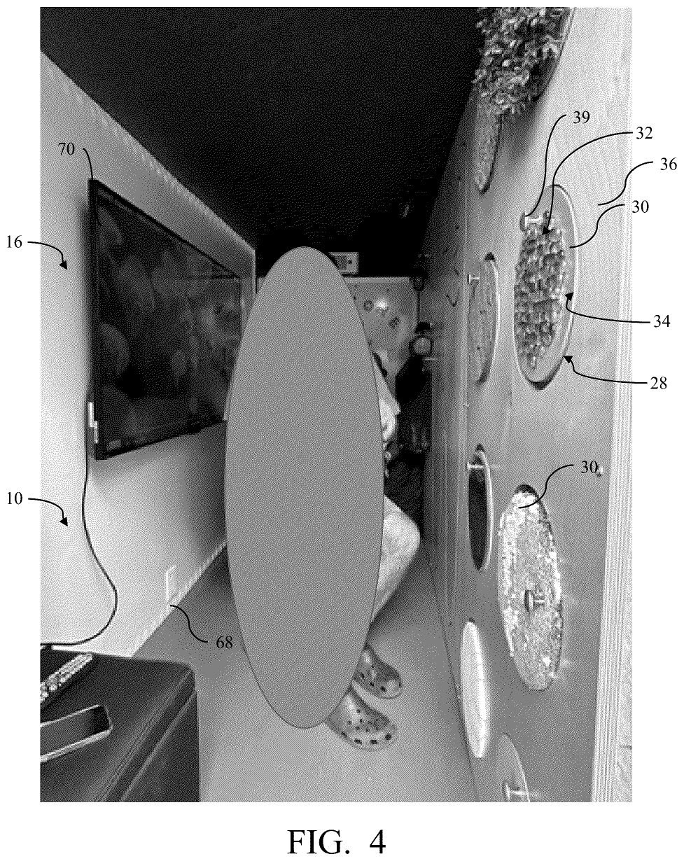

In some aspects, the sensory stimulation system 10 can comprise a lighting system 64 configured to illuminate the enclosure. For example, referring to FIG. 3, the lighting system comprises at least one strip of light emitting diodes (LEDs) 66 extending along the ceiling. For example, as illustrated, the lighting system can comprise a plurality of longitudinally extending strips of LEDs 66. In various aspects, the lighting system can be configured to emit light based on a selected illumination setting. For example, the brightness color, or pattern of the light (e.g., colors and/or variations in colors) can be adjusted. Optionally, in these aspects, the LED strips can be in communication with a user input device (e.g., a remote control) that is configured to permit selection of the selection illumination setting. In some aspects, the lighting system can comprise at least one panel 68 (FIG. 4) that diffuses light emitted about its perimeter.

In some aspects, the sensory stimulation system 10 can comprise an audio system configured to produce auditory stimuli. Optionally, the audio system can include headphones in communication with an audio content source. In additional aspects, the audio system can comprise a plurality of speakers coupled to the enclosure. The auditory stimuli can include white or gray noise or music.

In some aspects, the sensory stimulation system 10 can comprise an electronic display 70 configured to present visual stimuli. For example, the electronic display can be a TV screen or computer monitor. The electronic display can be in communication with a content source that is configured to output visual (and, optionally, sound) to the electronic display.

In some aspects, the sensory stimulation system 10 can comprise a climate control system configured to control a temperature within the enclosure. The climate control system can comprise a heater, an air conditioner, a fan, or a combination thereof.

The sensory stimulation system 10 can comprise non-slip flooring within the enclosure. For example, the non-slip flooring can comprise rubber. The flooring can further be padded.

In some aspects, the sound insulation system 18 can comprise at least one acoustic panel 72 extending along at least one wall of the plurality of walls. For example, in some aspects, at least one acoustic panel 72 can extend along both sidewalls 52. In further aspects, at least one acoustic panel 72 can extend along the forward wall 54. In further aspects, at least one acoustic panel 72 can extend along the forward wall 54 the rear wall 56. In further aspects, the sound insulation system can comprise at least one acoustic panel 72 extending along the ceiling of the enclosure. In exemplary aspects, the at least one acoustic panel 72 can have a wavy or undulating profile. In further aspects, the at least one acoustic panel 72 can comprise a sound-absorbing material. In some aspects, the sound insulation system 18 can inhibit sound exterior to the enclosure from entering the interior space 16 of the enclosure. Further, the sound insulation system 18 can absorb sound emitted from within the interior space 16 of the enclosure 14 to reduce ambient noise. It is contemplated that multi-sensory rooms are conventionally provided in buildings where external noise is not an issue. For example, multi-sensory rooms can be found in homes of those who need them or in environments specifically selected for accommodating the room, such as an occupational therapist office. In contrast, the disclosed sensory stimulation system 10 can be provided to noisy or crowded environments, where external environmental sound cannot be controlled. The disclosed sensory stimulation system 10 can be configured to isolate the interior space 16 of the enclosure 14 from external sound and stimuli that can be undesirable. Further, in some aspects, the vehicle can generate undesirable noise (e.g., via the engine). The sound insulation system 18 can be configured to insulate the interior space 16 of the enclosure 14 from noise from the vehicle. Accordingly, it is contemplated that the disclosed system is subject to challenges that are nonexistent for conventional multi-sensory rooms.

The sensory stimulation system 10 can comprise a plurality of electrical outlets 74 within the enclosure. For example, the sensory stimulation system 10 can comprise a plug that is configured to connect to a grounded power source. The plug can provide electricity to the plurality of electrical outlets 74.

The sensory stimulation system 10 can comprise at least one seat within the enclosure. For example, the at least one seat can include one or more of a stool, a bean bag chair, or a chair suspended from the ceiling 62 of the enclosure. In exemplary aspects, the enclosure can accommodate at least four stools/seats.

Referring also to FIG. 4, the plurality of sensory elements can comprise a plurality of tactile elements, each tactile element defining a different respective textured surface. For example, the sensory stimulation system 10 can comprise a mounting surface 34. The plurality of tactile elements 30 can be removably coupled to the mounting surface 34 by respective attachment elements. The attachment elements can comprise, for example, hook and loop material, magnets, or snaps. In this way, the plurality of tactile elements 30 can be rearranged. In some aspects, each tactile element 30 can comprise a respective handle 39 that is configured to permit removal of the each tactile element from mounting surface 34. In still further aspects, the sensory stimulation system 10 can comprise a board 36 defining a plurality of openings 38 that are each configured to receive therein a respective tactile element of the plurality of tactile elements. The plurality of tactile elements can comprise at least one of: a rough surface, a smooth, flat surface, a glassy surface, a felt surface, a stone surface, corrugated cardboard, a tiled surface, a bumpy surface, a textile, an artificial turf, a carpet, or other industrial finishes. The plurality of tactile elements can further comprise one or more of: a surface of an acrylic element, a surface of a silicone element, a sculpted material (e.g., sculpted wood or foam), or a mirror.

In some aspects, the plurality of sensory elements comprise at least one musical instrument. Optionally, in these aspects, the at least one musical instrument can comprises a percussion instrument. The percussion instrument can be a bell, a drum, or a xylophone.

In some aspects, the plurality of sensory elements 20 can comprise a peg board.

In some aspects, the sensory stimulation system 10 can comprise comprising an aromatherapy diffuser.

In some aspects, the sensory stimulation system 10 can comprise at least one fiber optic cable.

In some aspects, the sensory stimulation system 10 can comprise at least one lamp. For example, optionally, the at least one lamp can comprise a lava lamp or a bubble lamp.

In some aspects, the plurality of sensory elements comprise at least one magnetic surface 40 configured to permit arrangement of magnetic elements thereon. The sensory stimulation system 10 can further comprise a plurality of magnetic elements that are coupled to the at least one magnetic surface.

In some aspects, the sensory stimulation system 10 can comprise at least one fiber

In some aspects, the plurality of sensory elements 20 can comprise a pivotable panel coupled to at least one wall of the plurality of walls.

In some aspects, the sensory stimulation system 10 can comprise at least one outdoor device that is removable from the enclosure, wherein the at least one outdoor device comprises at least one of: a trampoline, a rope, a slam ball, or a crash pad.

In some aspects, the plurality of sensory elements 20 can comprise at least one surface configured to permit coloring or drawing; and removal of the coloring or drawing. Optionally, in these aspects, the at least one surface comprises a paper drawing pad or an erasable board. In additional aspects, the at least one surface configured to permit coloring or drawing can comprise a color changing touch surface (e.g., a finger-tracing panel).

In some aspects, the sensory stimulation system 10 can comprise one or more of: marble panels, an abacus, strings, flexible tubing (e.g., rubber tubing), or a pegboard panel.

In some aspects, the enclosure 14 can have a length of less than 14 feet and a width of less than 9 feet. For example, the enclosure can have a length from about 8 feet to about 14 feet. In further aspects, the enclosure can have a width from about 4 feet to about 7 feet. Conventionally, multi-sensory rooms are large to provide space for movement and experience of different stimuli in different areas. The disclosed sensory stimulation system 10 can have dimensions at that are substantially reduced from conventional multi-sensory rooms. The smaller dimensions of the system disclosed herein have been found to provide equivalent or improved results as compared to conventionally large multi-sensory rooms.

The disclosed sensory stimulation system 10, by being mobile, can be delivered to a site. The stimulation system can then be moved to a second site. Accordingly, the sensory stimulation system 10 can provide the disclosed advantages in a temporary location. The temporary location can be, for example, a public gathering, a fair, a concert, or a festival. Some specific examples can include public or state fairs, including a general campus or at a performance or exhibitor's space, art/food truck/film festivals, themed venues such as a Renaissance festival. More examples of a site for the sensory stimulation system 10 can include service providers, such as adult and pediatric clinics, hospitals, occupational or physical therapy clinics, daycares, wellness facilities or events, education such as private or public pre-school/K12/college, homecoming/prom/sorority/fraternity/welcome weeks or back to school events, performance arts groups, nonprofit organizations providing services relevant to the general, or shared service populations, such as veterans affairs sites, Special Olympics events, a zoo, transitional housing. Additional examples can include retail locations, such as cause-marketing events, malls, banks, stores, holiday and seasonal markets. Further examples of sites can include outdoor and indoor sports tournaments, including, for example, colleges, outdoor community events such as Special Olympics or use inside arenas, schools and sports complexes. Still further examples can include corporate facilities, such as client events, public conferences. VIP lounges, or employee-only events. Additional site examples can include professional development conferences, private event, such as birthday parties, weddings, reunions; fundraising events, such as galas or benefit experiences.

Although the foregoing invention has been described in some detail by way of illustration and example for purposes of clarity of understanding, certain changes and modifications may be practiced within the scope of the appended claims.

What is claimed is:

1. A sensory stimulation system comprising:
a wheeled chassis;
an enclosure coupled to the wheeled chassis, wherein the enclosure surrounds an interior space;
a sound insulation system at least partly surrounding the interior space; and
a plurality of sensory elements within the enclosure, wherein the plurality of sensory elements comprise at least one of:
at least one tactile element defining a textured surface;
at least one puzzle;
at least one surface configured to permit:
coloring or drawing; and
removal of the coloring or drawing;
at least one magnetic surface configured to permit arrangement of magnetic elements thereon; or
at least one musical instrument.

2. The sensory stimulation system of claim 1, wherein the enclosure is integrally formed with the wheeled chassis.

3. The sensory stimulation system of claim 2, wherein the sensory stimulation system comprises a van, wherein the van comprises the enclosure and the wheeled chassis.

4. The sensory stimulation system of claim 1, further comprising a lighting system configured to illuminate the enclosure.

5. The sensory stimulation system of claim 4, wherein the lighting system is configured to emit light based on a selected illumination setting.

6. The sensory stimulation system of claim 4, wherein the enclosure comprises a ceiling, wherein the lighting system comprises at least one strip of light emitting diodes (LEDs) extending along the ceiling.

7. The sensory stimulation system of claim 6, further comprising a user input device that is configured to permit selection of the selection illumination setting.

8. The sensory stimulation system of claim 1, further comprising an audio system configured to produce auditory stimuli.

9. The sensory system of claim 8, wherein the audio system comprises headphones in communication with an audio content source.

10. The sensory system of claim 8, wherein the audio system comprises a plurality of speakers coupled to the enclosure.

11. The sensory stimulation system of claim 1, further comprising an electronic display configured to present visual stimuli.

12. The sensory stimulation system of claim 1, further comprising a climate control system configured to control a temperature within the enclosure.

13. The sensory stimulation system of claim 1, wherein the enclosure comprises a plurality of walls, the plurality of walls comprising:
a pair of side walls spaced along a transverse axis, wherein the pair of sidewalls have forward ends and rear ends; and
a forward wall extending between the forward ends of the pair of sidewalls,
wherein the plurality of sensory elements are positioned on respective walls of the plurality of walls.

14. The sensory stimulation system of claim 13, wherein the enclosure further comprises at least one door positioned at the rear ends of the sidewalls, wherein the plurality of walls further comprise a rear wall that is pivotable about and between:
a first position that extends across the at least one door; and
a second position that is pivoted away from the first position to permit access to the at least one door, wherein at least one sensory element of the plurality of sensory elements is positioned on the rear wall.

15. The sensory stimulation system of claim 1, further comprising non-slip flooring within the enclosure.

16. The sensory stimulation system of claim 15, wherein the non-slip flooring comprises rubber.

17. The sensory stimulation system of claim 1, wherein the enclosure comprises a plurality of walls, wherein the sound insulation system comprises at least one acoustic panel extending along at least one wall of the plurality of walls.

18. The sensory stimulation system of claim 17, wherein the enclosure comprises a ceiling, wherein the sound insulation system comprises at least one acoustic panel extending along the ceiling of the enclosure.

19. A method comprising:
moving a sensory stimulation system as disclosed herein to a first site.

20. The method of claim 19, wherein the site is a public gathering, a fair, a concert, a festival, a service provider location, a school, an athletic event, a retail location, a professional development conference, or a private event.
